(19) United States
(12) Patent Application Publication
(10) Pub. No.: US 2017/0277412 A1
(43) Pub. Date: Sep. 28, 2017

(54) METHOD FOR USE OF VIRTUAL REALITY IN A CONTACT CENTER ENVIRONMENT

(71) Applicant: INTERACTIVE INTELLIGENCE GROUP, INC., Indianapolis, IN (US)

(72) Inventors: Ryan B. Curtis, Madison, WI (US); Payvand Moaddel, Madison, WI (US); Richard J. Walsh, Raleigh, NC (US); Donald E. Brown, Indianapolis, IN (US)

(21) Appl. No.: 15/346,832

(22) Filed: Nov. 9, 2016

Related U.S. Application Data
(60) Provisional application No. 62/313,912, filed on Mar. 28, 2016.

(51) Int. Cl. G06F 3/0484; G06Q 30/06; G06F 3/0482; H04L 29/06; H04L 29/08

(52) U.S. Cl. CPC G06F 3/04845; H04L 67/42; H04L 67/02; G06F 3/0482; G06Q 30/0613; G06Q 30/0643; H04W 88/02

(57) ABSTRACT

A method is presented for the use of virtual reality in a contact center environment. A customer may be viewing a virtual reality scene in a virtual reality environment and desire to initiate an interaction from within the virtual reality world. The interaction may be to bring in one or more additional parties to the virtual reality session. The customer may want to connect with an agent in a contact center and/or with an additional party at any time during the session. An interaction may be initiated from a menu of options in real-time, allowing for a customer to share their virtual reality session with the one or more additional parties.

### CROSS-REFERENCE TO RELATED APPLICATIONS

This application claims priority to U.S. provisional application 62/313,912 filed Mar. 28, 2016, entitled “Usage of Virtual Reality in a Contact Center Environment,” the contents of which are incorporated herein.

### BACKGROUND

The present invention generally relates to telecommunications systems and methods, as well as virtual reality. More particularly, the present invention pertains to the integration of communications with a virtual reality environment.

### SUMMARY

A method is presented for the use of virtual reality in a contact center environment. A customer may be viewing a virtual reality scene in a virtual reality environment and desire to initiate an interaction from within the virtual reality world. The interaction may be to bring in one or more additional parties to the virtual reality session. The customer may want to connect with an agent in a contact center and/or with an additional party at any time during the session. An interaction may be initiated from a menu of options in real-time, allowing for a customer to share their virtual reality session with the one or more additional parties.

In one embodiment, a method is presented for a real-time virtual reality interaction, in a contact center environment, between a plurality of parties, the method comprising the steps of: viewing a virtual reality scene, by a first party, through a mobile device operatively coupled with a virtual reality viewing device; navigating, by the first party, through the virtual reality scene utilizing strategically placed waypoints, wherein the waypoints provide access to other virtual reality scenes in the world; accessing a point in space comprising a menu of options, wherein an option in the menu comprises the ability to connect with an other party; and connecting, by the first party with the other party, wherein the other party has the capability to interact with the first party and see what the first party is viewing.

In another embodiment, a method is presented for a real-time virtual reality interaction, in a contact center environment, between a plurality of parties, the method comprising the steps of: viewing a virtual reality scene, by a first party, through a mobile device operatively coupled with a virtual reality headset; navigating, by the first party, through the virtual reality scene utilizing strategically placed waypoints, wherein the waypoints provide access to other virtual reality scenes in the world; accessing a point in space comprising a menu of options, wherein an option in the menu comprises the ability to connect with an other party; and connecting, by the first party with the other party, wherein the other party has the capability to interact with the first party and see what the first party is viewing.

### BRIEF DESCRIPTION OF THE DRAWINGS

FIG. 1 is a flowchart illustrating an embodiment of a process for connecting to a contact center system.

FIG. 2 is a flowchart illustrating an embodiment of a process for connecting to a contact center system.

FIG. 3 is a flowchart illustrating an embodiment of a process for connecting to a contact center system.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

A virtual reality environment might comprise computer technologies using software to generate realistic images for a viewer. Sounds may also be generated to replicate an environment in order to provide a user with an authentic experience in an environment. A user is able to interact with and view the virtual reality environment through various means, such as through headsets, allowing the user to be brought into the virtual world without external distractions. Users have been able to interact in virtual environments for video games, or other forms of entertainment, with the technology becoming more mainstream. More recently, the travel industry has begun to use virtual reality for interactions.

In a contact center environment utilized in the travel industry, for example, virtual reality might be utilized for a customer and an agent to interact through avatars. The travel industry has used virtual reality to enable potential consumers to view cruise cabins, tourism content, and hotel rooms prior to booking. Customers might borrow devices and view potential vacation destinations. A customer might already be connected to a travel agent and virtually viewing a potential vacation destination while speaking with the agent; however, if a customer is already in a virtual world, the ability of the customer to reach out to an agent through the virtual reality environment (and to additional parties) with real-time communication is needed.

With the availability of virtual reality viewing devices (e.g., Google's Cardboard) and headsets (e.g., Oculus Rift), it is easier to have capabilities to access a virtual reality environment. A customer's mobile device may have an application installed on it which works in conjunction with the viewing device or the headset, allowing the customer access to different virtual reality environments. The ability to place real-time communications through the virtual environment to a contact center system allows a user, while within the virtual reality environment, to connect in real-time with an agent at any time while browsing the virtual reality environment. An incoming communication from the customer may be routed as a session through an ACD as a new media type (e.g., a virtual reality session) to an agent in a unified communications collaboration system, such as Interactive Intelligence Group, Inc.'s, PureCloud platform.

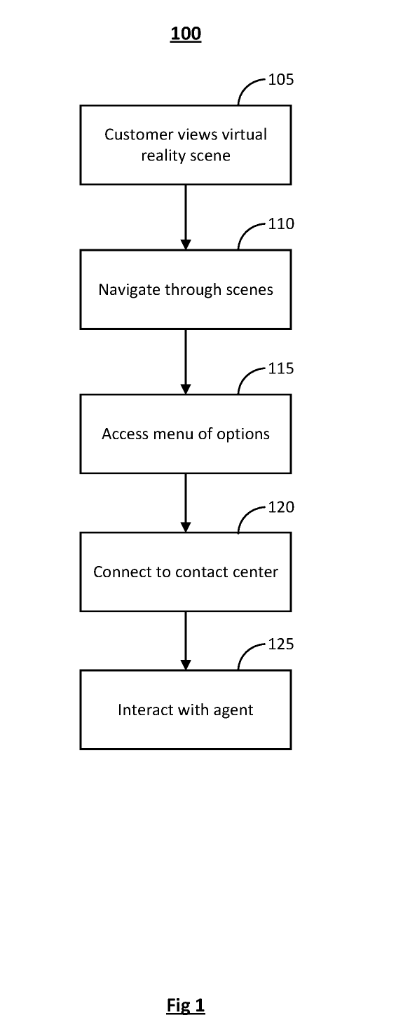

FIG. 1 is a flowchart illustrating an embodiment of a process for connecting to a contact center system, indicated generally at 100. In this process, a customer may be viewing a virtual reality environment and wishing to connect with a contact center agent during their experience.

In operation 105, a customer views a virtual reality scene in a virtual reality environment. For example, the customer may be viewing a virtual reality scene using different methods. In an embodiment, the customer may be using a mobile device operatively coupled with a virtual reality viewing device. The mobile device might be a smartphone or a tablet, to name some non-limiting examples, which the customer places into a viewing device (e.g., Google Cardboard) and views the virtual reality scene with the aid of the viewing device. The mobile device may have a software application installed which facilitates access to the virtual reality environment. The application communicates with a server which comprises defined scenes within a virtual reality world. The application downloads the scenes from the server. In an embodiment, scenes comprise pictures which have been taken and stitched together. Scenes might also comprise 360-degree videos of the real world or even be completely computer generated. In an embodiment, if the mobile device does not have the software application installed, the mobile device might be in communication with a website housing the virtual reality world. In another embodiment, the customer might be viewing the virtual reality scene using a virtual reality headset where the application is already pre-loaded. Control is passed to operation 110 and the process 100 continues.

In operation 110, the customer navigates through scenes. For example, the customer may navigate through a virtual reality scene utilizing strategically placed ‘waypoints’. Waypoints comprise a visual indicator to the customer of a portal which allows the customer to move between scenes in the virtual reality world. The waypoints may be accessed using a reticle, for example, or another means which comprises a grid/pattern to establish scale or position. The waypoint is selected by positioning the reticle over the waypoint, by the customer. Positioning might be done by the customer moving their head to align the reticle with the waypoint. In order to select the waypoint, in an embodiment, the customer may press a button on the viewing device, which is operatively coupled to the mobile device and triggers the action of the reticle. In another embodiment, the customer may simply press a button on the headset. In yet another embodiment, the customer may utilize a hand controller to navigate. In another embodiment, instead of using waypoints to navigate, the customer may be able to walk around in real space. Control is passed to operation 115 and the process 100 continues.

In operation 115, the customer accesses a menu of options. The customer may decide they are at a place where they need to bring in another party or perform an action. In order to do this, for example, the customer may access a point in space comprising a menu of options within the virtual reality environment. In an embodiment, the point in space might comprise a floor menu or a heads-up display (HUD), which may be present regardless of the scene the customer might be viewing within the virtual reality world. Options within the menu provide further means for a customer to navigate and perform actions within the virtual reality world. For example, an option might comprise the ability of the customer to connect with an other party, such as an agent within a contact center or bringing in another desired party, such as a significant other or an interested party. The customer might be viewing scenes for a potential vacation location and would like to share the view with a significant other or a friend. The customer could then, through the menu, select to place a connection. The connection may be placed via a WebRTC session, a phone call, or video chat, to name a few non-limiting examples. In this example, the customer is wishing to connect with an agent in a contact center. Control is passed to operation 120 and the process 100 continues.

In operation 120, the customer connects to a contact center. For example, the customer has placed an interaction through the menu. In an embodiment, the customer has elected to connect with an agent in the contact center by selecting the option which initiates an interaction. The selection of an option in the menu may be made using a reticle or through another means, such as voice command or controls which are handheld or located on the headset, for example. Control is passed to operation 125 and the process 100 continues.

In operation 125, the customer interacts with a contact center agent and the process ends. An incoming communication from the customer may be routed as a session through an ACD as a new media type (e.g., a virtual reality session) to an agent in a unified communications collaboration system, such as Interactive Intelligence Group, Inc.'s, PureCloud platform. The interaction between the customer and the agent is performed in real-time. In an embodiment, the agent may have the capability to interact with the customer and have access to what the customer is viewing. The agent may also have the ability to track where and what the customer is viewing during the interaction. The agent might also be able to aid the customer in a variety of ways. For example, the customer might be able to demonstrate to the agent an action they are trying to take and the agent can in turn provide assistance. Actions might comprise failure by a customer to access a waypoint, requiring assistance in viewing a particular scene, requiring navigational assistance, or help in making a purchase in the application, to name a few non-limiting examples. An agent may also be able to change the scene or view of the customer based on the interaction. At the conclusion of the interaction, the customer may terminate their virtual reality session in the environment, or they may continue browsing the environment, always having the ability to reconnect with an agent should the need arise.

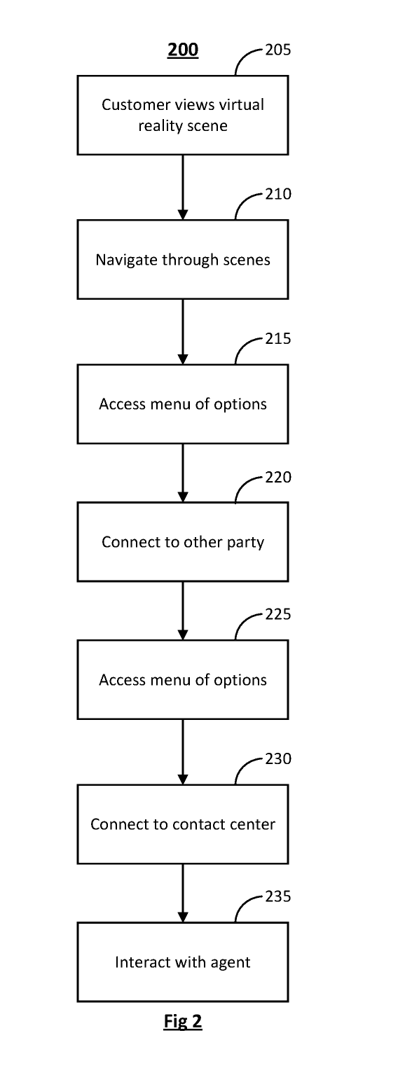

In another embodiment, a customer Mary, may be viewing scenes in the virtual reality environment for a trip to a location, such as Madison, Wis., for example. She may want to bring her husband Dan in to her viewing experience to see the pictures. Mary may want to determine if he has any interest in visiting Madison for their next trip, prior to connecting with the agent in order to discuss further details. FIG. 2 is a flowchart illustrating another embodiment of a process for connecting to a contact center system, indicated generally at 200. In this process, a customer (e.g., Mary from the above example) may be viewing a virtual reality environment and wishing to share their experience with another party (e.g., Dan from the above example) and then connecting with a contact center agent during their experience.

In operation 205, a customer views a virtual reality scene in a virtual reality environment. For example, the customer may be viewing a virtual reality scene using different methods. In an embodiment, the customer may be using a mobile device operatively coupled with a virtual reality viewing device. The mobile device might be a smartphone or a tablet, to name some of non-limiting examples, which the customer places into a viewing device (e.g., Google Cardboard) and views the virtual reality scene with the aid of the viewing device. The mobile device may have a software application installed which facilitates access to the virtual reality environment. The application communicates with a server which comprises defined scenes within a virtual reality world. The application downloads the scenes from the server. In an embodiment, scenes comprise pictures which have been taken and stitched together. Scenes might also comprise 360-degree videos of the real world or even be completely computer generated. In an embodiment, if the mobile device does not have the software application installed, the mobile device might be in communication with a website housing the virtual reality world. In another embodiment, the customer might be viewing the virtual reality scene using a virtual reality headset where the application is already pre-loaded. Control is passed to operation 210 and the process 100 continues.

In operation 210, the customer navigates through scenes. For example, the customer may navigate through a virtual reality scene utilizing strategically placed ‘waypoints’. Waypoints comprise a visual indicator to the customer of a portal which allows the customer to move between scenes in the virtual reality world. The waypoints may be accessed using a reticle, for example, or another means which comprises a grid/pattern to establish scale or position. The waypoint is selected by positioning the reticle over the waypoint, by the customer. Positioning might be done by the customer moving their head to align the reticle with the waypoint. In order to select the waypoint, in an embodiment, the customer may press a button on the viewing device, which is operatively coupled to the mobile device and triggers the action of the reticle. In another embodiment, the customer may simply press a button on the headset. In yet another embodiment, the customer may utilize a hand controller to navigate. In another embodiment, instead of using waypoints to navigate, the customer may be able to walk around in real space. Control is passed to operation 215 and the process 200 continues.

In operation 215, the customer accesses a menu of options. The customer may decide they are at a place where they need to bring in another party or perform an action. In order to do this, for example, the customer may access a point in space comprising a menu of options within the virtual reality environment. In an embodiment, the point in space might comprise a floor menu or a HUD, which may be present regardless of the scene the customer might be viewing within the virtual reality world. Options within the menu provide further means for a customer to navigate and perform actions within the virtual reality world. For example, an option might comprise the ability of the customer to connect with an other party, such as an agent within a contact center or bringing in another desired party, such as a significant other or an interested party. The customer might be viewing scenes for a potential vacation location and would like to share the view with a significant other or a friend. The customer could then, through the menu, select to place a connection. The connection may be placed via a WebRTC session, a phone call, or video chat, to name a few non-limiting examples. In this example, the customer (Mary) is wishing to connect with an additional party (her husband Dan). Additional parties may comprise anyone, such as a significant other, friend, relative, or someone not related to the contact center associated with the application. Control is passed to operation 220 and the process 200 continues.

In operation 220, the customer connects to another party. For example, the customer wishes to connect with a related party they want to share the virtual reality environment with. In an embodiment, the application might receive input from the customer identifying an additional participant to join the interaction, such as through speech, a virtual keyboard, a contact list, etc. The application may also determine the virtual environment capabilities of the additional participant, which may be based on the current interaction and/or the customer making the request. The location within the virtual reality world would be provided to the additional participant so that they are able to be at the same location as the customer. The additional party may join the interaction using the information provided through their own headset or their mobile device coupled to a virtual reality viewing device. Additionally, in an embodiment, if the additional party does not have access to a headset or a virtual reality viewing device, they may access a website which provides a 360-degree view of the same view as the customer. It should be noted that it is within the scope of the embodiments for any number of parties to be added to an interaction, thus, the process of adding additional parties to an interaction may be repeated any number of desired times. Control is passed to operation 225 and the process 200 continues.

In operation 225, the customer accesses a menu of options. The customer, Mary, has shown Dan what a lovely city Madison is and they have decided to bring in a contact center agent to the interaction. For example, the customer may access a point in space comprising a menu of options within the virtual reality environment. In an embodiment, the point in space might comprise a floor menu or a HUD, which may be present regardless of the scene the customer might be viewing within the virtual reality world. Options within the menu provide further means for a customer to navigate and perform actions within the virtual reality world. For example, an option might comprise the ability of the customer to connect with an other party, such as an agent within a contact center or bringing in another party. The customer could then, through the menu, select to place a connection. The connection may be placed via a WebRTC session, a phone call, or video chat, to name a few non-limiting examples. In this example, the customer is wishing to connect with an agent. In an embodiment, a group interaction may then be initiated. In an embodiment, the additional party may also initiate the interaction with the customer service agent. In another embodiment, the additional party may decide not to be a party to the interaction and terminate their interaction at any time. Control is passed to operation 230 and the process 200 continues.

In operation 230, the customer connects to a contact center. For example, the customer has placed an interaction through the menu. In an embodiment, the customer has elected to connect with an agent in the contact center by selecting the option which initiates an interaction. The selection of an option in the menu may be made using a reticle or through another means, such as voice command or controls which are handheld or located on the headset, for example. Control is passed to operation 235 and the process 200 continues.

In operation 235, the customer interacts with a contact center agent and the process ends. An incoming communication from the customer may be routed as a session through an ACD as a new media type (e.g., a virtual reality session) to an agent in a unified communications collaboration system, such as Interactive Intelligence Group, Inc.'s, PureCloud platform. The interaction between the customer(s) and the agent is performed in real-time. In an embodiment, the agent may have the capability to interact with the customer(s) and have access to what the customers are viewing. The agent may also have the ability to track where and what the customers are viewing during the interaction. The agent might also be able to aid the customer in a variety of ways. For example, a customer might be able to demonstrate to the agent an action they are trying to take and the agent can in turn provide assistance. Actions might comprise failure by a customer to access a waypoint, requiring assistance in viewing a particular scene, requiring navigational assistance, or help in making a purchase in the application, to name a few non-limiting examples. An agent may also be able to change the scene or view of the customers based on the interaction. At the conclusion of the interaction, the customers may terminate their virtual reality session in the environment, or they may continue browsing the environment, always having the ability to reconnect with an agent should the need arise.

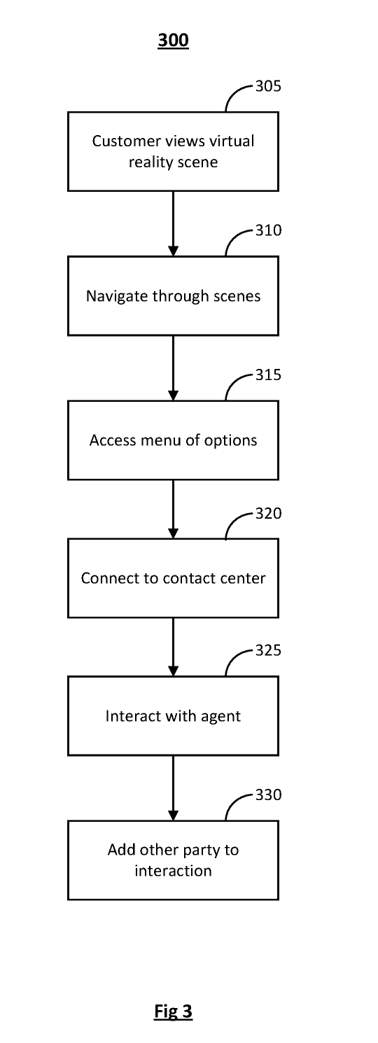

In another embodiment, a customer Mary may be viewing scenes in the virtual reality environment, contact an agent, but then decide she needs to bring her husband Dan into the interaction with the agent. FIG. 3 is a flowchart illustrating an embodiment of a process for connecting to a contact center system, indicated generally at 300. In this process, a customer may be viewing a virtual reality environment and wishing to connect with a contact center agent during their experience. The addition of a third party to the interaction between the contact center agent and the customer may then be desired.

In operation 305, a customer views a virtual reality scene in a virtual reality environment. For example, the customer may be viewing a virtual reality scene using different methods. In an embodiment, the customer may be using a mobile device operatively coupled with a virtual reality viewing device. The mobile device might be a smartphone or a tablet, to name some non-limiting examples, which the customer places into a viewing device (e.g., Google Cardboard) and views the virtual reality scene with the aid of the viewing device. The mobile device has a software application installed which facilitates access to the virtual reality environment. The application communicates with a server which comprises defined scenes within a virtual reality world. The application downloads the scenes from the server. In an embodiment, scenes comprise pictures which have been taken and stitched together. Scenes might also comprise 360-degree videos of the real world or even be completely computer generated. In an embodiment, if the mobile device does not have the software application installed, the mobile device might be in communication with a website housing the virtual reality world. In another embodiment, the customer might be viewing the virtual reality scene using a virtual reality headset where the application is already pre-loaded. Control is passed to operation 310 and the process 300 continues.

In operation 310, the customer navigates through scenes. For example, the customer may navigate through a virtual reality scene utilizing strategically placed ‘waypoints’. Waypoints comprise a visual indicator to the customer of a portal which allows the customer to move between scenes in the virtual reality world. The waypoints may be accessed using a reticle, for example, or another means which comprises a grid/pattern to establish scale or position. The waypoint is selected by positioning the reticle over the waypoint, by the customer. Positioning might be done by the customer moving their head to align the reticle with the waypoint. In order to select the waypoint, in an embodiment, the customer may press a button on the viewing device, which is operatively coupled to the mobile device and triggers the action of the reticle. In another embodiment, the customer may simply press a button on the headset. In yet another embodiment, the customer may utilize a hand controller to navigate. In another embodiment, instead of using waypoints to navigate, the customer may be able to walk around in real space. Control is passed to operation 315 and the process 300 continues.

In operation 315, the customer accesses a menu of options. The customer may decide they are at a place where they need to bring in another party or perform an action. In order to do this, for example, the customer may access a point in space comprising a menu of options within the virtual reality environment. In an embodiment, the point in space might comprise a floor menu or a HUD, which may be present regardless of the scene the customer might be viewing within the virtual reality world. Options within the menu provide further means for a customer to navigate and perform actions within the virtual reality world. For example, an option might comprise the ability of the customer to connect with an other party, such as an agent within a contact center or bringing in another desired party, such as a significant other or an interested party. The customer might be viewing scenes for a potential vacation location and would like to share the view with a significant other or a friend. The customer could then, through the menu, select to place a connection. The connection may be placed via a WebRTC session, a phone call, or video chat, to name a few non-limiting examples. In this example, the customer is wishing to connect with an agent in a contact center. Control is passed to operation 320 and the process 300 continues.

In operation 320, the customer connects to a contact center. For example, the customer has placed an interaction through the menu. In an embodiment, the customer has elected to connect with an agent in the contact center by selecting the option which initiates an interaction. The selection of an option in the menu may be made using a reticle or through another means, such as voice command or controls which are handheld or located on the headset, for example. Control is passed to operation 325 and the process 300 continues.

In operation 325, the customer interacts with a contact center agent. An incoming communication from the customer may be routed as a session through an ACD as a new media type (e.g., a virtual reality session) to an agent in a unified communications collaboration system, such as Interactive Intelligence Group, Inc.'s, PureCloud platform. The interaction between the customer and the agent is performed in real-time. In an embodiment, the agent may have the capability to interact with the customer and have access to what the customer is viewing. The agent may also have the ability to track where and what the customer is viewing during the interaction. The agent might also be able to aid the customer in a variety of ways. For example, the customer might be able to demonstrate to the agent an action they are trying to take and the agent can in turn provide assistance. Actions might comprise failure by a customer to access a waypoint, requiring assistance in viewing a particular scene, requiring navigational assistance, or help in making a purchase in the application, to name a few non-limiting examples. An agent may also be able to change the scene or view of the customer based on the interaction. At the conclusion of the interaction, the customer may terminate their virtual reality session in the environment, or they may continue browsing the environment, always having the ability to reconnect with an agent should the need arise. In an embodiment, the agent may also have the ability to add another party to the interaction. Control is passed to operation 330 and the process 300 continues.

In operation 330, another party is added to the interaction and the process 300 ends. For example, after the agent has been contacted by the customer, an additional party may be desired to be brought in. Mary may have decided to add Dan to the interaction after discussing her plans with the agent. She may indicate to the agent that she wishes to add in another party to the interaction. In another example, the agent may wish to bring in another contact center employee such as an agent or supervisor to aid in the interaction.

The additional party may be brought in by the contact center agent to the interaction. The connection may be placed via a WebRTC session, a phone call, or video chat, to name a few non-limiting examples. The agent may use information provided by the customer or the contact center system to initiate the addition of the desired party. The location within the virtual reality world would be provided to the additional participant so that they are able to be at the same location as the customer. The additional party may join the interaction using the information provided through their own headset or mobile device coupled to a virtual reality viewing device. Additionally, in an embodiment, if the additional party does not have access to a headset or a virtual reality viewing device, they may access a website which provides a 360-degree view of the same view as the customer.

Similar to FIG. 2, an agent may be able to view what the added party is viewing, perform actions, and change views for the added party in addition to the customer. It should be noted that it is within the scope of the embodiments for any number of parties to be added to an interaction, thus, the process of adding additional parties to an interaction may be repeated any number of desired times. Parties may leave or join the interaction as needed. At the conclusion of the interaction, the customers may terminate their virtual reality session in the environment, or they may continue browsing the environment, always having the ability to reconnect with an agent should the need arise.

In addition to the embodiments described above, the contact center may be able to collect data and information about the interactions between the customer and the agent in the virtual reality world after the customer has connected with the agent. The data may be aggregated with data from other interactions in order to improve the customer experience. For example, metrics may be collected regarding how long a user stays in a scene or where the customer enters/exits the virtual reality world. Metrics may also be used to understand success/failures within the virtual reality world. Additionally, audio, gaze detection, or gaze direction might be utilized. Metric collections might be a continuous stream of data or provided upon termination of the virtual reality environment interaction.

In another embodiment, targeted advertising within the virtual reality world might be utilized, where advertisements might appear in a scene. The contact center might track the customers to determine views and alter advertisements based on the customer behavior. Machine learning may be leveraged in order to accomplish this.

In another embodiment, one of the parties to the interaction may not have virtual reality capabilities, such as not having access to the application through their mobile device. The party may be able to view a webpage with the same view as the user having virtual reality capabilities on a computer, tablet, or smartphone.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for a real-time virtual reality interaction, in a contact center environment, between a plurality of parties, the method comprising the steps of:
a. viewing a virtual reality scene, by a first party, through a mobile device operatively coupled with a virtual reality viewing device;
b. navigating, by the first party, through the virtual reality scene utilizing strategically placed waypoints, wherein the waypoints provide access to other virtual reality scenes in the world;
c. accessing a point in space comprising a menu of options, wherein an option in the menu comprises the ability to connect with an other party; and
d. connecting, by the first party with the other party, wherein the other party has the capability to interact with the first party and see what the first party is viewing.

2. The method of claim 1, wherein step (d) is repeated for additional parties wherein at least one of the additional parties comprises an agent in the contact center environment.

3. The method of claim 1, wherein the mobile device comprises a smartphone or a tablet.

4. The method of claim 1, wherein the mobile device comprises a software application, wherein the application is capable of communication with a server comprising scenes defined in a virtual reality world.

5. The method of claim 4, wherein the other party added does not have the software application, but is capable of viewing the scene using a webpage on a computing device.

6. The method of claim 1, wherein the virtual reality viewing device comprises an appliance capable of positioning the mobile device for viewing by the first party.

7. The method of claim 4, wherein the virtual reality world comprises one or more scenes.

8. The method of claim 1, wherein the first party comprises a customer of the contact center environment.

9. The method of claim 1, wherein the waypoints may be accessed using a reticle.

10. The method of claim 9 further comprising positioning the reticle over the waypoint and the first party pressing a button on the viewing device, which is operatively coupled to the mobile device, and triggering the action of the reticle.

11. The method of claim 1, wherein the waypoint comprises a visual indicator of a portal to move between scenes.

12. The method of claim 1, wherein the point in space accessed comprises either a floor menu or a heads-up display.

13. The method of claim 1, wherein the other party comprises an agent in a contact center.

14. The method of claim 13, wherein the contact center aggregates data about the first party interacting in the environment after the first party has connected to the agent.

15. The method of claim 1, wherein the other party comprises a party associated with the first party.

16. The method of claim 1, wherein the connecting occurs via one of: WebRTC session, phone call, or video chat.

17. The method of claim 13, wherein the agent is capable of at least one of: changing the view of the first party and placing reference points in the scene.

18. The method of claim 1, wherein the connecting provides the first party with capability to demonstrate to the agent a desired action.

19. The method of claim 18, wherein the desired action comprises one or more of: failure to access a waypoint, assistance in viewing a particular scene, assistance in navigating the world, and assistance in making a purchase.

20. The method of claim 17, wherein the placing of reference points comprises the agent placing a marker.

21. The method of claim 14, wherein the data is learned from examining one or more of the following: how long the first party stays in the scene, where the first party enters the world, where the first party exits the world, what the first party focuses on within the scene.

22. The method of claim 21, wherein the learning is used for targeted advertising by the contact center.

23. A method for a real-time virtual reality interaction, in a contact center environment, between a plurality of parties, the method comprising the steps of:
a. viewing a virtual reality scene, by a first party, through a mobile device operatively coupled with a virtual reality headset;
b. navigating, by the first party, through the virtual reality scene utilizing strategically placed waypoints, wherein the waypoints provide access to other virtual reality scenes in the world;
c. accessing a point in space comprising a menu of options, wherein an option in the menu comprises the ability to connect with an other party; and
d. connecting, by the first party with the other party, wherein the other party has the capability to interact with the first party and see what the first party is viewing.

24. The method of claim 23, wherein step (d) is repeated for additional parties wherein at least one of the additional parties comprises an agent in the contact center environment.

25. The method of claim 23, wherein the mobile device comprises a smartphone or a tablet.

26. The method of claim 23, wherein the mobile device comprises a software application, wherein the application is capable of communication with a server comprising scenes defined in a virtual reality world.

27. The method of claim 26, wherein the virtual reality world comprises one or more scenes.

28. The method of claim 23, wherein the other party added does not have the software application, but is capable of viewing the scene using a webpage on a computing device.

29. The method of claim 23, wherein the first party comprises a customer of the contact center environment.

30. The method of claim 23, wherein the waypoints may be accessed using a reticle.

31. The method of claim 23, wherein the waypoint comprises a visual indicator of a portal to move between scenes.

32. The method of claim 23, wherein the point in space accessed comprises either a floor menu or a heads-up display.

33. The method of claim 23, wherein the other party comprises an agent in a contact center.

34. The method of claim 33, wherein the contact center aggregates data about the first party interacting in the environment after the first party has connected to the agent.

35. The method of claim 23, wherein the other party comprises a party associated with the first party.

36. The method of claim 23, wherein the connecting occurs via one of: WebRTC session, phone call, or video chat.

37. The method of claim 33, wherein the agent is capable of at least one of: changing the view of the first party and placing reference points in the scene.

38. The method of claim 23, wherein the connecting provides the first party with capability to demonstrate to the agent a desired action.

39. The method of claim 38, wherein the desired action comprises one or more of: failure to access a waypoint, assistance in viewing a particular scene, assistance in navigating the world, and assistance in making a purchase.

40. The method of claim 37, wherein the placing of reference points comprises the agent placing a marker.

41. The method of claim 34, wherein the data is learned from examining one or more of the following: how long the first party stays in the scene, where the first party enters the world, where the first party exits the world, what the first party focuses on within the scene.

42. The method of claim 41, wherein the learning is used for targeted advertising by the contact center.
